(19) United States
(12) Patent Application Publication
(10) Pub. No.: US 2002/0072925 A1
(43) Pub. Date: Jun. 13, 2002

(54) Posthumous communication

(76) Inventor: Todd Michael Krim, Hollywood, CA (US)

Correspondence Address: SHEARMAN & STERLING, 599 Lexington Avenue, New York, NY, 10022, US

(21) Appl. No.: 09/962,539

(22) Filed: Sep. 24, 2001

Related U.S. Application Data
(63) Continuation of application No. PCT/US00/08295, filed on Mar. 24, 2000.
(60) Provisional application No. 60/138,128, filed on Jun. 8, 1999.
(60) Provisional application No. 60/131,396, filed on Apr. 28, 1999.
(60) Provisional application No. 60/126,082, filed on Mar. 25, 1999.

(51) Int. Cl. G06F 17/60

(52) U.S. Cl. 705/1

(57) ABSTRACT

A computer system. A first interface is designed to initiate a person as a member in a computer-implemented content-delivery service, to receive computer-storable content from the member and designations of recipients of the received content, and to store the content for confidential access only by the member. A second interface is designed to receive a signal indicating the death of members of the service, perhaps from a second person, and on such receipt, to send electronic signals to the designated recipients, the signal providing the designated recipients with access to the computer-storable content.

### BACKGROUND OF THE INVENTION

This application is a continuation of and claims priority from copending international application serial no. PCT/US00/08295, filed Mar. 24, 2000, published in English under PCT Article 21(2) on Sep. 28, 2000, and designating the United States, which claims priority from U.S. provisional applications No. 60/138,128, filed Jun. 8, 1999, 60/131,396, filed Apr. 28, 1999, and 60/126,082, filed Mar. 25, 1999, all of which are hereby incorporated by reference herein in their entirety.

The invention relates to electronic mail communication systems.

### SUMMARY OF THE INVENTION

In general, in a first aspect, the invention features a method. A computer solicits from a person an electronic communication and designated recipients of the communication, and holds the electronic communication in a memory of the computer. Upon receiving notice of the death of the person, the communication is transmitted to the designated recipients.

In general, in a second aspect, the invention features a computer system. A first interface is designed to receive from a first person computer-storable content and designations of recipients of the received content, and to store the content for confidential access only by the first person. A second interface is designed to receive a signal from a second person, and on such receipt, to send electronic signals to the designated recipients, the signal providing the designated recipients with access to the computer-storable content.

Embodiments of the invention may incorporate one or more of the following features. The death notice may be received from a custodian appointed by the person. The custodian may receive notice of the appointment via an electronic mail automatically generated by the computer. The death notice may be received from a public source of vital records. The communication may be transmitted to one of the designated recipients on a date certain designated by the person. A communication may be designated by the person to be transmitted on incapacity or imminent death, to a recipient designated by the person. The electronic communication may be solicited through one or more structured query forms. The electronic communication may be solicited as free-form text. The appearance of a user interface for the soliciting may be customized to the appearance of a computer system of a third party, while performing the holding and transmitting steps at a remote computer. One of the designated recipients may be a group consisting of individual recipients, such that further editing of the communication designated for delivery to the group is effective as to all individual recipients of the group. The communication may be transmitted to at least one of the designated recipients as the content of an electronic mail message. The communication may be transmitted to at least one of the designated recipients as an attachment to an electronic mail message. The communication may be transmitted to at least one of the designated recipients as content retrieved from the memory in response to a demand by the recipient, the demand being responsive to an electronic mail conveying a network address of a location of the communication.

### BRIEF DESCRIPTION OF THE DRAWINGS

FIG. 1a is a flowchart.

FIG. 1b is a block diagram of a computer system.

FIGS. 2a-2d, 3a-3d, 4a-4c, and 5a-5f are screens from the operation of a computer program.

### DETAILED DESCRIPTION OF THE INVENTION

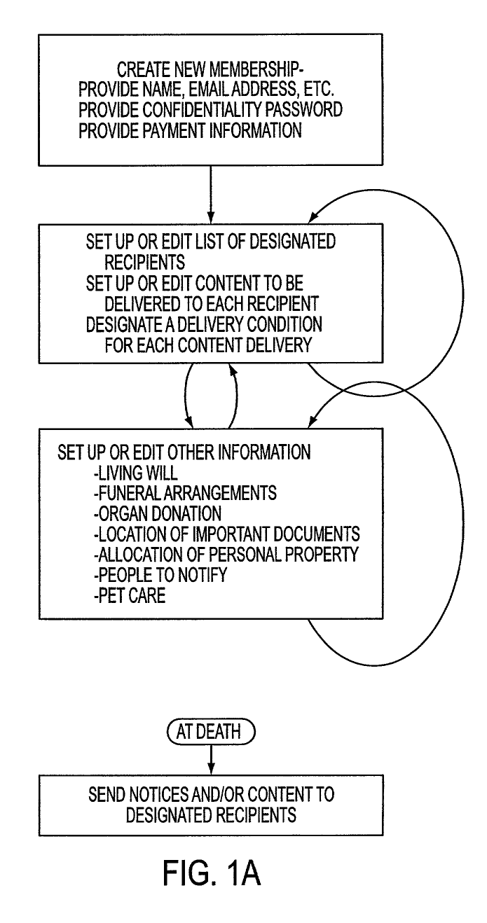

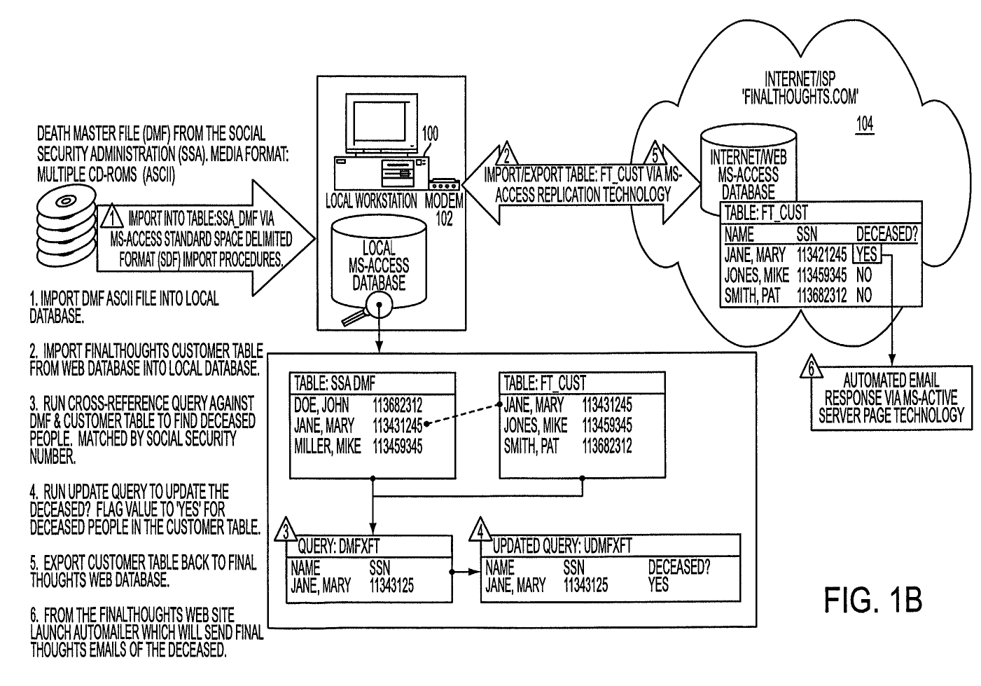

Referring to FIG. 1a, a delayed communication system provides a person with a number of options for specifying delivery of messages, graphics, or any other computer-storable content to designated recipients after the person has died. The system offers a number of formatted and free-form inputs, and several different options for receiving notice of the death of the member. The content is stored securely and confidentially at the delayed communication system, so that the person can edit, add, or delete messages to be delivered. When the system receives notice of the person's death, the content is emailed to the designated recipients, or each recipient is sent an email notifying the recipient that the content can be retrieved from the system.

Referring to FIG. 1b, the delayed communication system includes a server computer that maintains a number of databases 102. An internet web site front-end to the delayed communication system may be hosted 104 on another computer, typically a server provided by an ISP (internet service provider). The internet server, in turn, provides a connection to the internet and to its users. In other embodiments, the database server and the internet server may be the same computer.

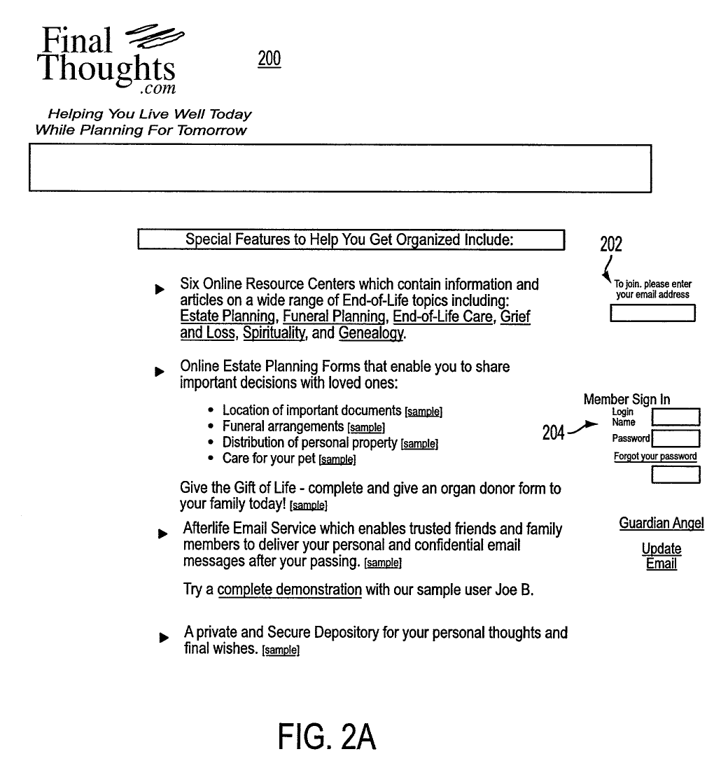

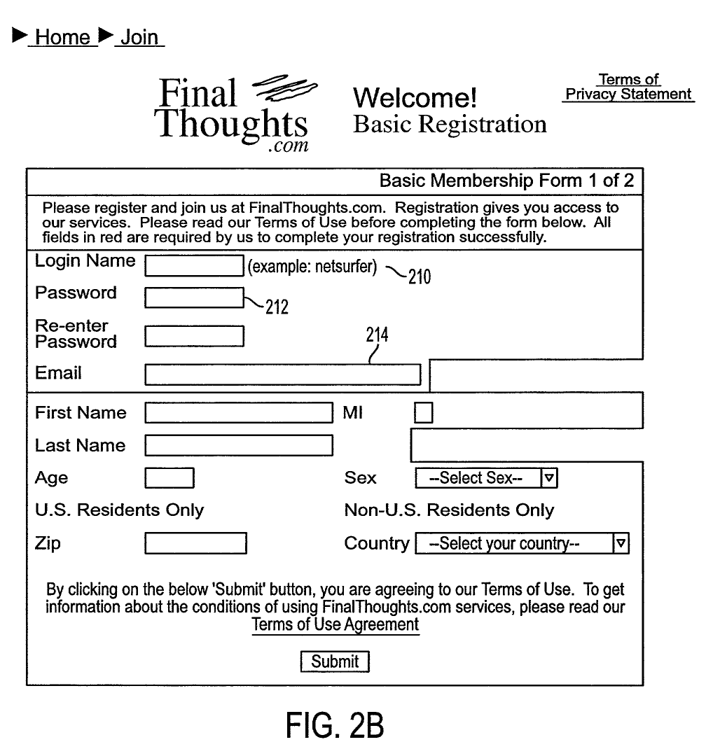

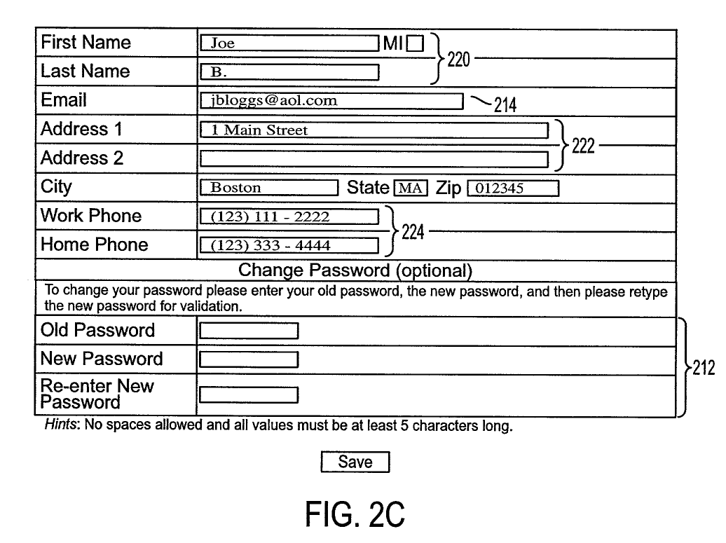

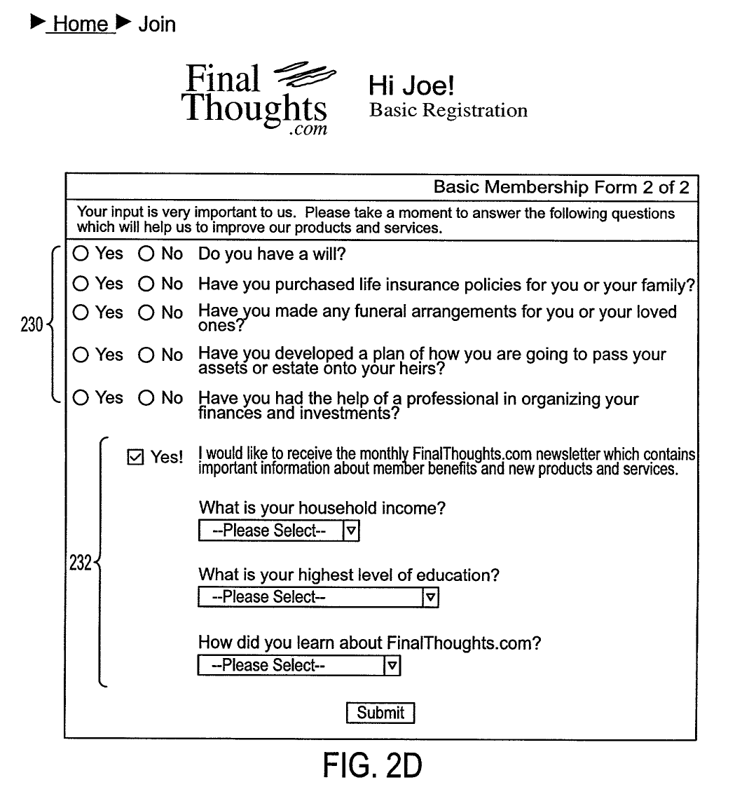

Referring to FIG. 2a, a person may enter the system by connecting to an internet web site, for instance, at www.finalthoughts.com. The person may join the system by clicking the “Join” button 202, or may login to the account of a pre-existing membership by entering the login name and password 204 assigned to that account when it was created.

Referring to FIG. 2b, a new member enters information about himself (pronouns such as “he,” “him,” “his,” and “himself” are used in their gender-neutral form in referring to the member). A new member must create a login name and password. The new member types in a login name 210, a password 212, and an email address 214. The login name becomes the index under which information about this member is stored in the databases 102. In embodiments that use passwords to protect the data of members, entry of the password 212 will be required to access the confidential information that the member stores on the delayed communication system, to ensure the member's privacy until disclosure is intended. Other privacy locks, for instance, answers to a group of personal questions, may be used as an alternative to a password, as is known in the art.

Referring to FIG. 2c, the new member enters more information. This information includes the member's name 220, email address 214, residential address 222, and telephone numbers 224. The system may require that some of this information (such as the member's name 220 and email address 214) be entered before the new member may progress to the next screen, and other information may be designated as optional. If the member wishes to use the “DMF” option described below, the member will be required to enter his social security number.

In the screen of FIG. 2c, the member may change his password 212.

Referring to FIG. 2d, the delayed communication system requests more information 230 about the new member, so that the system can tailor its services and ancillary advertising to the particular member. This information relates to, for instance, whether the member has a will, life insurance, an estate plan, has made funeral arrangements, and has had the help of a professional in organizing finances and investments. The delayed communication system may also request other demographic information 232, including household income, education, etc.

Membership may require a fee, in which case the system will request a credit card number or other billing contact.

Once the new member has entered the information requested in FIGS. 2b-2d, if a fee is to be charged, the delayed communication system posts a credit card transaction to the appropriate bank card computer. Then, if the charge is approved, or if no fee is required, a database record is created in member database 102. The member database record contains the information supplied by the new member in response to the screens of FIGS. 2b-2d.

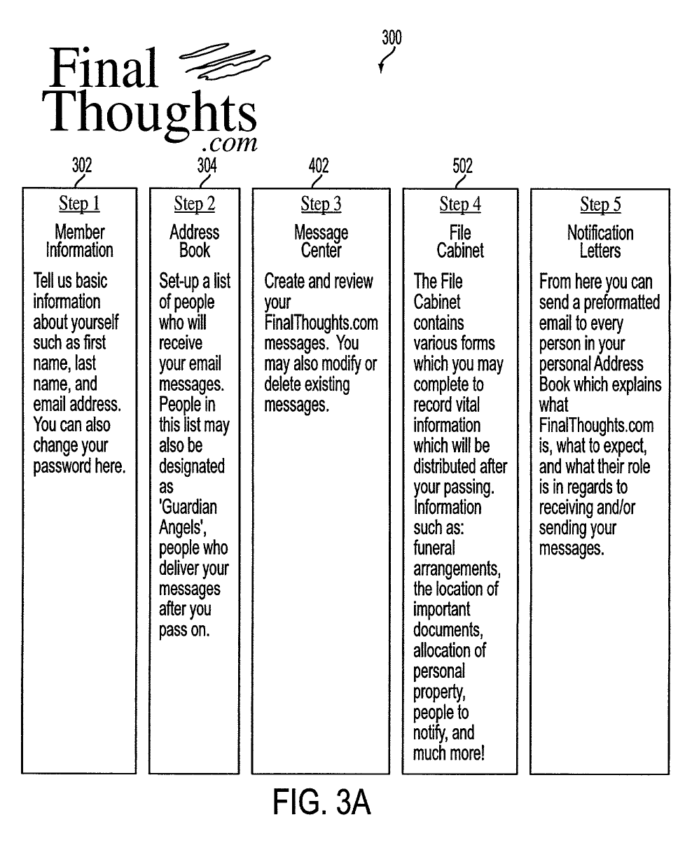

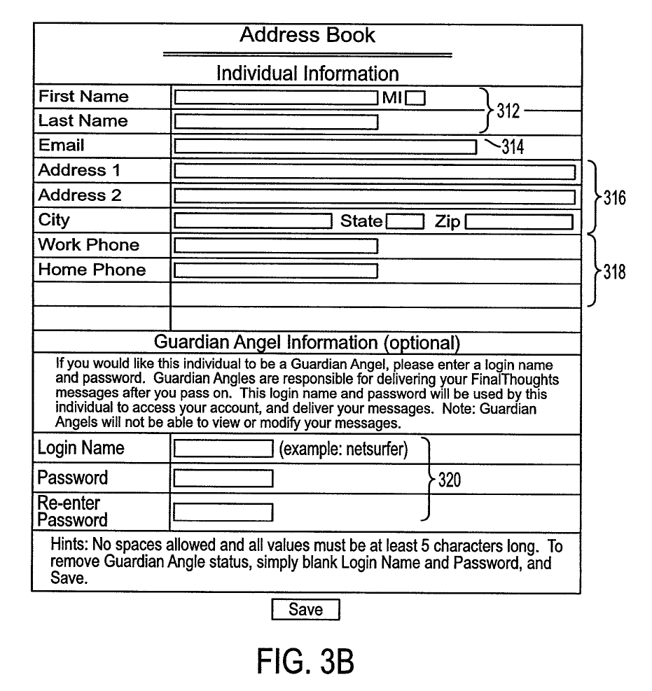

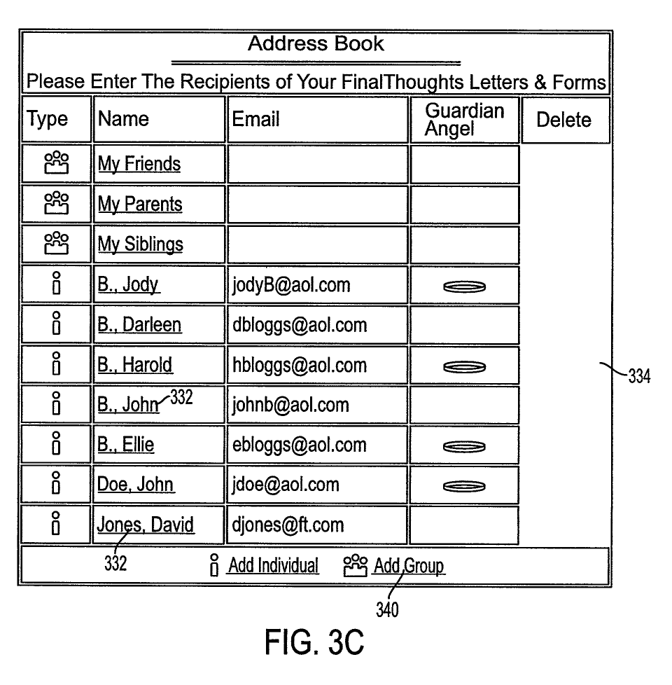

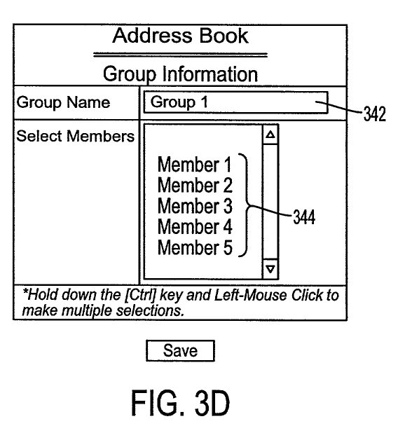

Referring to FIG. 3a, once a new membership is created, the member enters the “main menu” screen 300. From main menu 300, a member creates messages or content, and designates recipients to whom this content is to be sent when the system is notified of the member's death.

By clicking on function 302, the member may rerun the personal information entry functions of FIGS. 2b-2d, to edit, correct, or update information previously entered.

By clicking on function 304, the member may enter one or more names into an “address book” of recipients of messages. Referring to FIG. 3b, the member enters information describing each message recipient that the member would like to designate. The system requires that the member enter the first and last name 312 and email address 314 of each recipient. The system allows the member to enter alternate contact information, such as mailing address 316 and phone numbers 318.

In one mode, the delayed communication system relies on a custodian, a friend or relative of the member, to tell the system that the member has died (as will be discussed below, several other possible modes may be provided). In the figures, this custodian is called the “Guardian Angel;” the duties of the custodian will be discussed in detail below. (Pronouns such as “she” and “her” are used in their gender-neutral sense to refer to the custodian.) The member creates a login name and password 320 for the custodian; as discussed below, entry of this login name and password 320 may give the custodian limited access to the information entered by the member, will allow the custodian access to her own contact information, and will allow the custodian to inform the delayed communication system of the death of the member.

Referring to FIG. 3c, all designated recipients can be listed. By clicking on the recipient name 332, the member may return to the screen of FIG. 3b to edit the contact information 312-320. By clicking in “delete” column 334, the member may delete the recipient from the address book.

After clicking on “add group” button 340, the member enters the screen of FIG. 3d. The member may enter a group name 342, and then designate individual members 344 to form the group. As will be discussed below, a single message may be sent to a group, which simplifies sending a common message to multiple recipients.

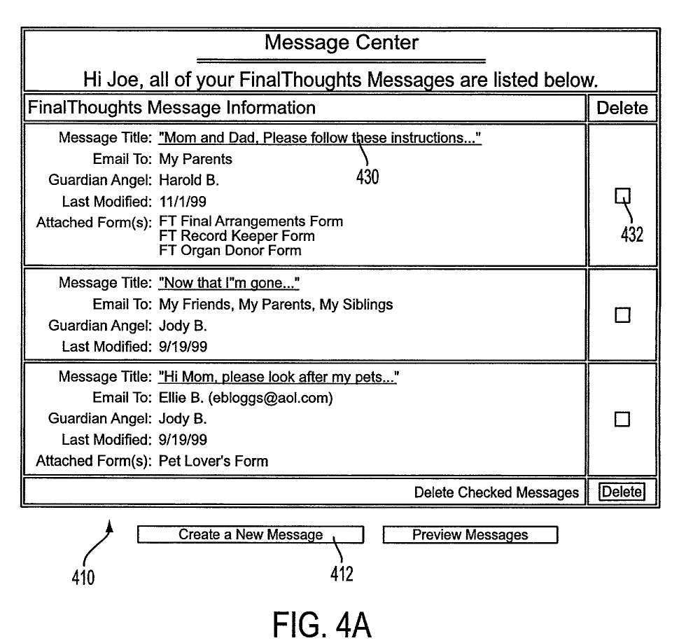

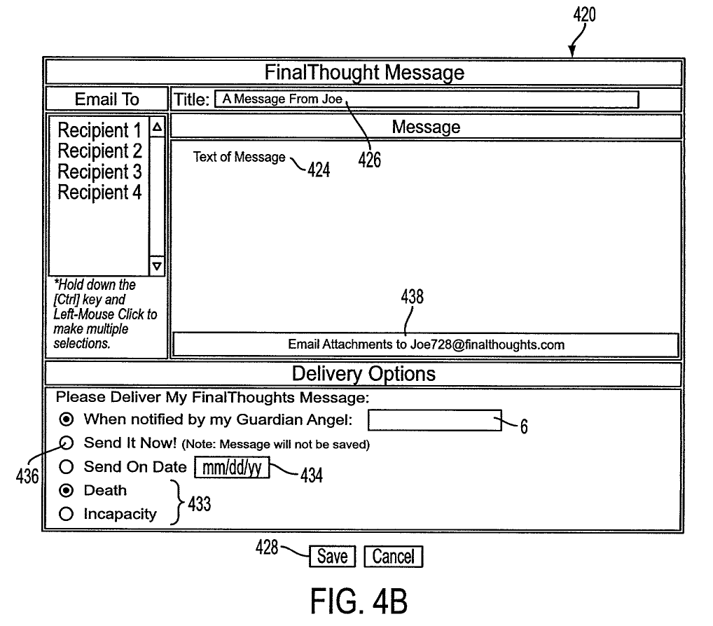

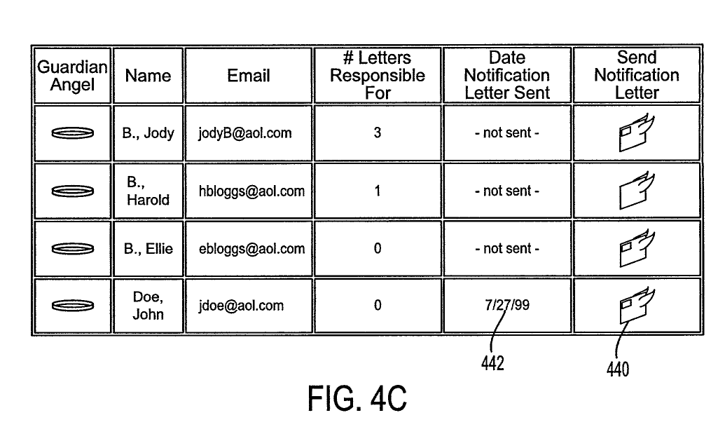

Referring again to FIG. 3a, by clicking on Message Center function 402, the member may enter the functions of FIGS. 4a-4b to enter, edit, correct, or update messages to people or groups listed in the address book.

Referring to FIG. 4a, the Message Center menu 410 shows all of the messages that have currently been created, and the recipient(s) to whom each is addressed. By clicking on button 412, the member accesses a Message Composition screen 420 of FIG. 4b. Message Composition screen 420 lists the recipients 422 that were entered into the address book. The member selects one or more of the individual or group recipients 422, and enters a message text 424 and a title 426. The member may also select a background graphic for the message. When the member clicks the Save button 428, the message and its associated list of recipients is saved. The next time the Message Center menu screen 410 of FIG. 4a is displayed, it will include the new message among the messages listed 410. The member can edit the text of a message, or change the list of recipients, by clicking on the title 430 of the message to be altered. Messages may be deleted by clicking button 432.

The member may designate an event 433 that is to trigger the sending of the associated messages.

For instance, some messages may be designated to be sent in case of severe illness, injury, incapacitation, or imminent death. These messages might include a preference for a particular hospital or hospice, a living will specifying desired aggressiveness of treatment, etc., a designation of a health care proxy, organ donation designations (which organs or tissues may be donated, and for what uses—transplantation or treatment, medical study, etc.).

Other messages, to be sent at death, may include the following:

Friends, family, etc. to be notified of the member's death and funeral;

Whether the member has will or living trust, and the location of the original document;

Whether the member owns a life insurance policy, pension, retirement account, annuity, other death benefit, or other account whose status is affected by death, and the location of any documents;

Locations of any bank or securities accounts, safe deposit boxes, etc. and the location of any associated records; and

Any other important information about the family, such as photographs, heirlooms, etc.

The member may also share valuable family history to be passed down to future generations. The member may record and document their memorable and life-enriching experiences with their family and friends to be shared with these family and friends at the member's death.

Other messages may be designated for delivery on a date certain 434, or for immediate delivery 436.

Any message created by the member will be held in confidence by the delayed communication system, under password access, until the message is sent to its designated recipient or recipients. The number of messages that a single member may create may be limited by the system designer to some maximum number such as ten or fifty, or may be left unlimited up to the maximum capacity of the disk.

In some embodiments, the member may provide clip art, video or audio clips to be included in one or more of his messages. For instance, the Message Center screen of FIG. 4b may include an email address 438. A member may send an email to this address with any desired content as an attachment. The delayed communication system will detach the attachment from the email sent in by the member, and attach it to the designated message as an attachment for delivery as specified 433, 436.

Referring to FIG. 4c, the member may instruct the system to send a notification to each custodian and recipient, by clicking on a “send mail” icon 440 associated with the custodian or recipient. This notification message is sent more or less immediately (unlike the postponement applied to the messages entered at Message Composition screen 420). Each notification informs the recipient or custodian that a member has designated him or her as a recipient or custodian, and invites the recipient or custodian to visit the delayed communication system's web site to learn more, and to notify the system whenever the recipient or custodian changes email addresses. The system maintains a record 442 of when the last notification letter was sent to each recipient or custodian.

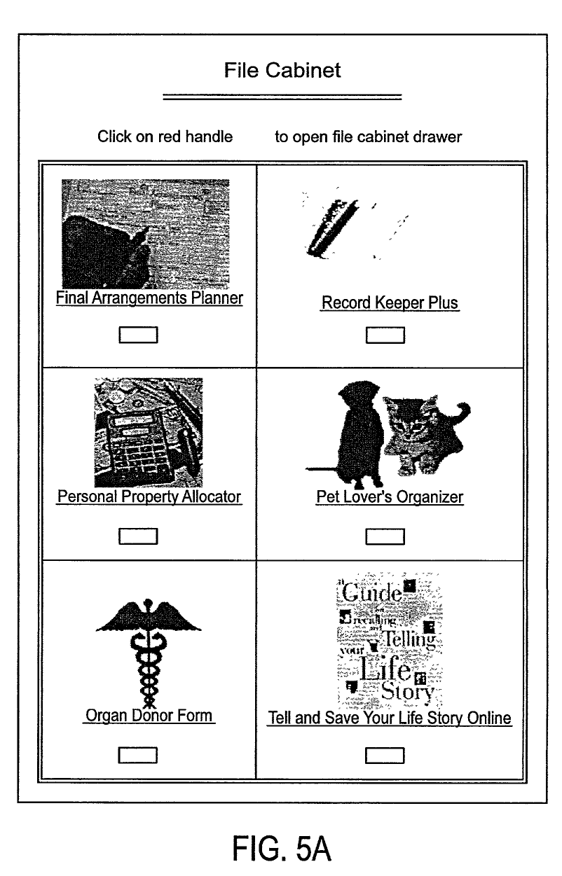

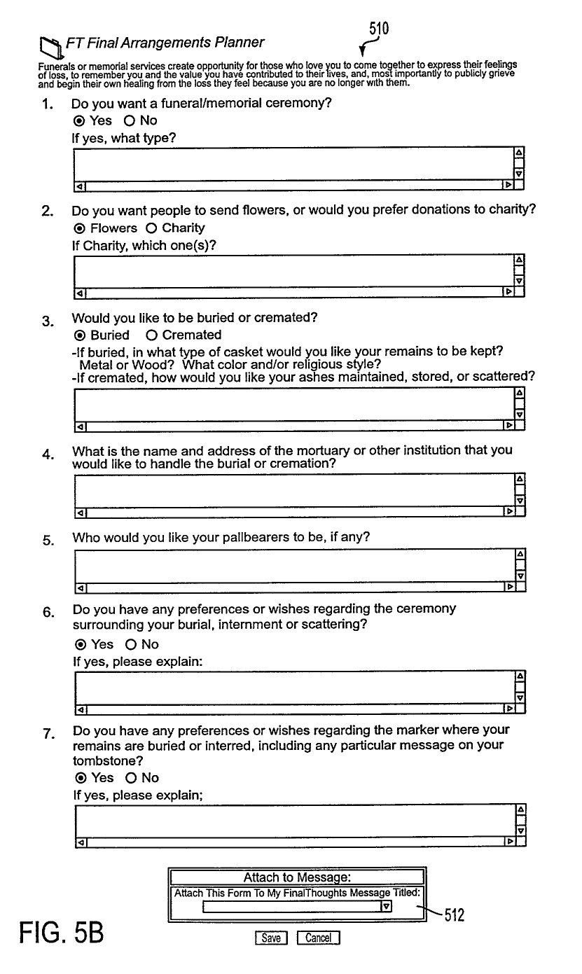

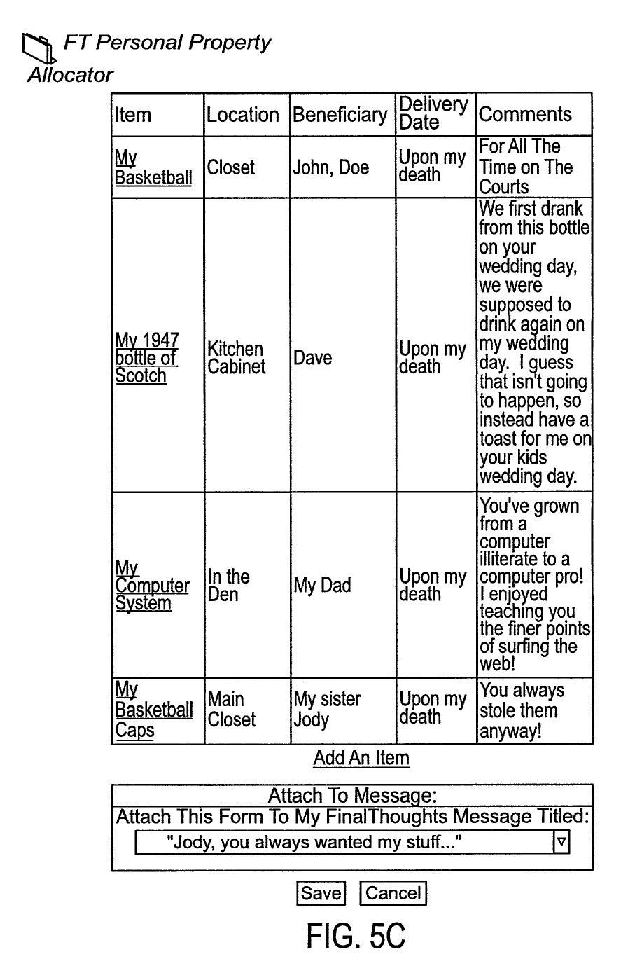

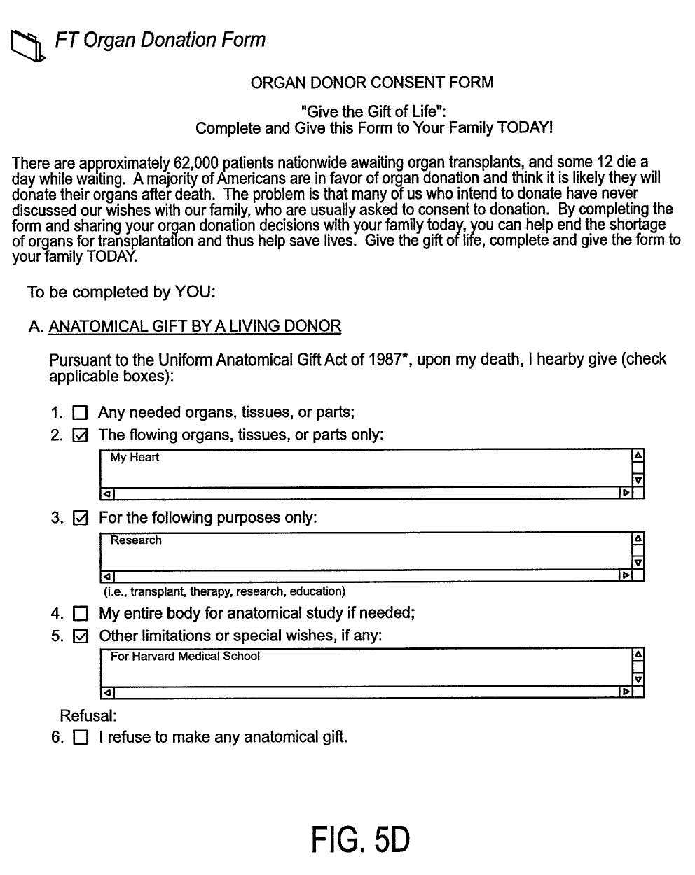

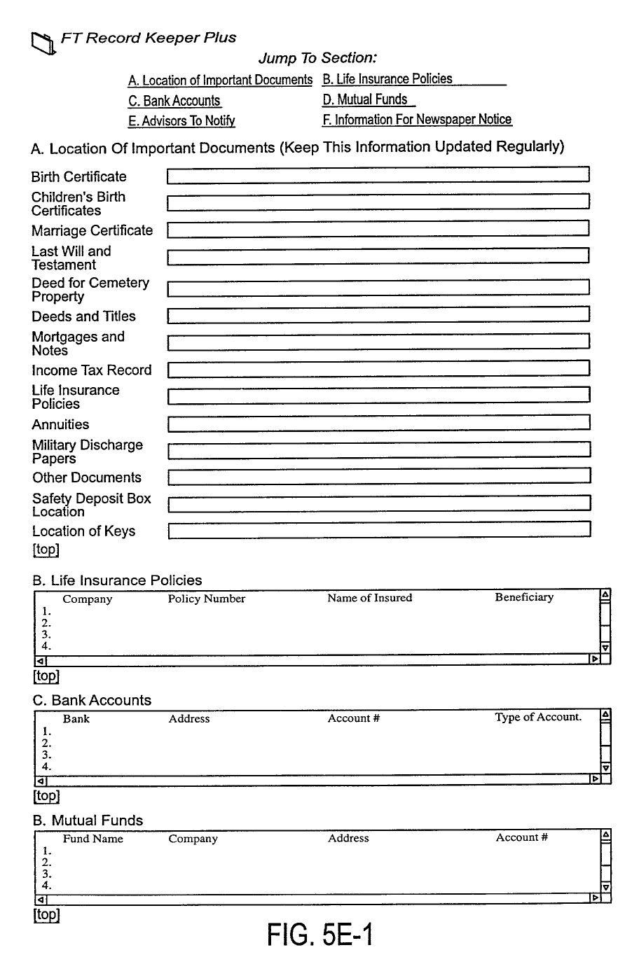

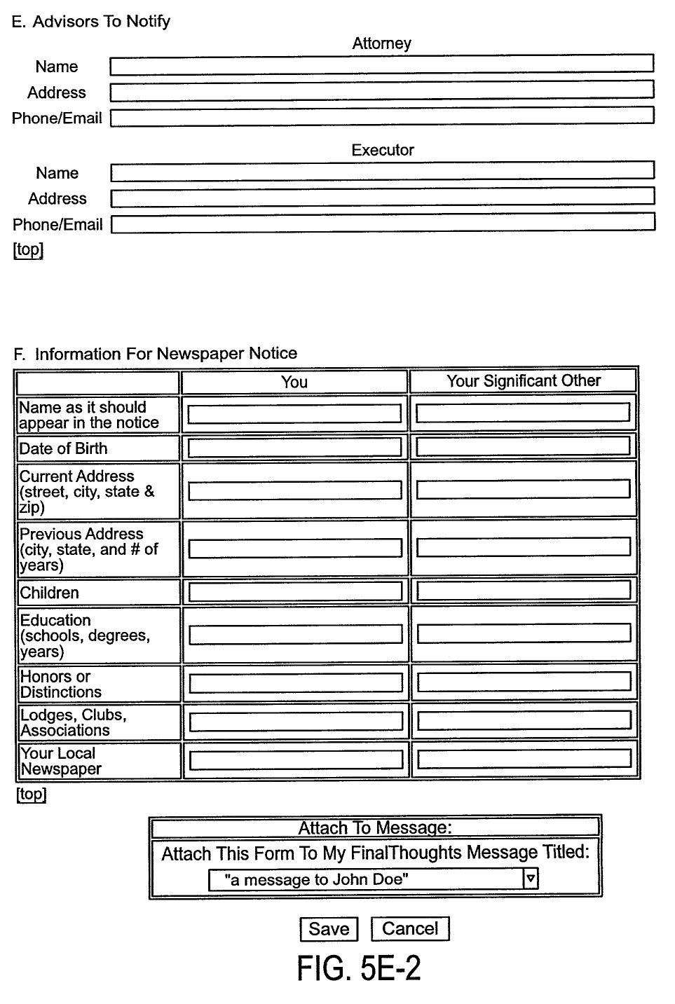

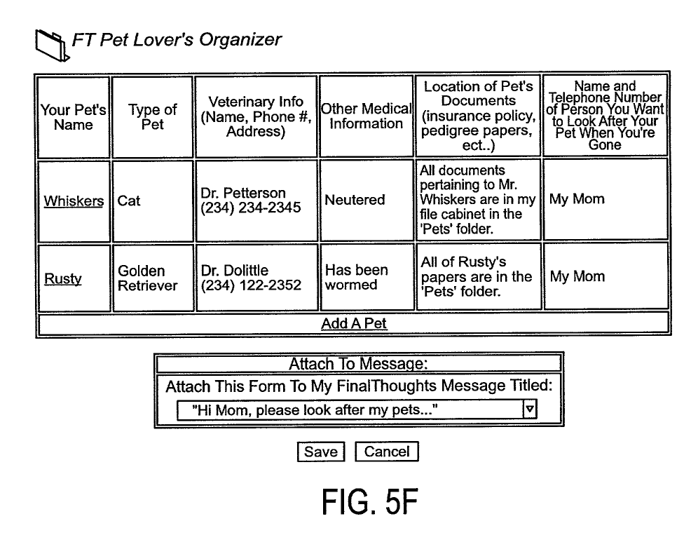

Referring again to FIG. 3a, by clicking on the File Cabinet function 402, the member may enter the functions of FIGS. 5a-5b to obtain structured forms that prompt the member to enter certain information.

Referring to FIG. 5b, a final arrangements planner 510 allows the member to designate a number of aspects of his funeral and memorial arrangements, for instance preferences for the type of ceremony, whether to decline flowers in favor of charitable contributions to a designated charity, whether to be buried or cremated, where the remains are to be interred, preferred marker epitaph or other indicia, etc. At the bottom of the final arrangements planner, a drop-down menu 512 allows the member to designate one or messages to which the final arrangements information should be attached.

Referring to FIG. 5c. a personal property allocator allows a member to provide instructions for distribution of his personal property, such as jewelry, watches, clothes, photographs, etc.

Referring to FIG. 5d, an organ donor form allows a member to notify next of kin and physicians of his wishes with respect to organ and tissue donation—whether donation is desired, what organs are tissues are available, what type of donation (therapeutic or for study), etc. FIG. 5d shows only the first page of such a form; the remainder of the organ donor form is conventional.

The Personal Property Allocator and Organ Donor forms may carry legends that they may be legally ineffective in some states, in view of the requirements for formalization of testamentary documents. In alternate embodiments, these pages may include features that will allow them to acquire an electronic signature that may render them legally effective as the law of electronic signatures matures.

Referring to FIG. 5e, a record keeper prompts a member to document where important documents, such as one's will, life insurance policies, real estate deeds, etc., are stored for quick and immediate access by his family.

Referring to FIG. 5f, a pet lover's organizer allows a member who owns pets to provide important information regarding disposition of the pets.

A guide for recalling and telling a life story may be provided to prompt a member to recount information that will be valuable to survivors, such as details of birth, childhood, parents, grandparents, siblings, growing up, school, relatives, friends, neighbors, work, etc.

Referring to FIG. 6a in conjunction with FIG. 4b, the system may provide a member with several selections for delivery options for each message. These options may include two or more of (a) immediate, (b) on a date certain, (c) on notification of death or incapacitation by a custodian, (d) on notification of death by way of the Social Security Administration's Death Master File, or another public record.

The “immediate delivery option 436 was discussed above.

The date certain delivery option (434 of FIG. 4b) allows the member to enter a specific date on which he would like a message to be sent. This delivery option permits the member to create one ore more email messages well in advance of a special occasion, such as a birthday, anniversary, holiday, etc. This option may be used when a member is going on a trip or will otherwise be incommunicado, or may be used in contemplation of death, to prearrange a message for the upcoming special occasion. The “date certain” option may call for recurring messages to be sent, for instance an annual message on an anniversary or birthday.

A custodian may be appointed to trigger the sending of messages. A drop-down list on the Message Composition screen of FIG. 4b displays all of the individual recipients listed in the member's address book, and the member may appoint one or more of these recipients as a custodian. The custodian will have the ability to sign-on to the delayed communication system using a user name and password created for her by the member, and to trigger sending of the messages that the member placed under her custodianship. The user name and password for the custodian are selected by the member; this preserves the member's ability to revoke the custodian's appointment. Upon sign-on, the custodian will only have partial access to those messages specifically designated by the member. Generally, the member will not permit the custodian the ability to review or revise the content of the email messages, nor to select which messages are to be sent, though in some embodiments, such capability may be provided. The system will recommend to the member that the custodian be someone he trusts, such as a close friend or family member, or someone in a fiduciary capacity, such as an accountant or attorney. The system provides the member the ability to change the appointment of a custodian at any time. The member will be prompted to create a new username and password for each new custodian. In order to protect the privacy and confidentiality of the members' email messages, once a person has been removed as a custodian, his or her username and password will no longer be valid.

The system may provide a fourth option, under which messages will be sent when the member's death is recognized from publication in some official record. For instance, the Social Security Administration makes death records available through its Death Master File (DMF). Quarterly updates of the DMF can be purchased on CD ROM. The operators of the delayed communication system may periodically purchase a set of these CD ROM's, and load them into a database structured for more convenient query. Then the delayed communication system will query this database for the existence of each member. Alternatively, some jurisdictions' Departments of Vital Statistics (DVS) may make such records available on the internet. For instance, if the DVS in the member's jurisdiction provides web access to its database, the member may instruct the delayed communication system how to query the DVS database, and then the delayed communication system may periodically poll the DVS web site for the member's death. When the member's presence is noted in one of these databases, the member's messages will be sent as the member has instructed.

The system may cause some event in the physical world, typically by placing an order though an on-line service. For instance, the member may request that flowers be delivered to survivors every year on an anniversary date, by placing an order with an internet florist. The service may be requested by an email to the service vendor.

In some embodiments, there may be a fee charged for the delayed communication service. Members may be charged a one-time fee for registering, a per-message fee for creating each new message, or a periodic fee for maintaining the messages. The member may supply a credit card number to which any fee is charged.

When registration is complete, the member may request the system to send a notification message to each recipient a notification that a delayed message is pending for the recipient. The name of the member that created the message may or may not be disclosed in the notification message, depending on implementation of the system, and the choice of the member. In order to ensure that each intended recipient can receive her delayed email in the future, she will be advised to contact the delayed communication system in the event she changes her email address. The system may send periodic reminders to members and recipients to keep their email addresses and contact information up to date.

A member can sign on at any subsequent time and change his messages, the designated recipients of any message, or the information in any of the forms of FIGS. 5a-5g.

The message database 102 tracks the status of each reception of each message. The message may be “pending,” that is, held in abeyance until the delayed communication system learns of the death of the member, or the reception of the message may be “notified,” indicating that an email has been sent to the recipient indicating the availability of the message to be read but the message itself has not been retrieved from the system, or the message may be “read,” indicating that the recipient has actually logged into the delayed communication system to retrieve the message.

If the date certain delivery option is implemented, the delayed communication system periodically initiates a background process to review the contents of the message database. The current date is compared against the delivery date of any message that is scheduled to be delivered at a date certain. For any message that is now due to be delivered, a notification is sent to the recipient, and the message is marked in “notified” status.

When a custodian provides notice of the death of a member, the delayed communication system sends notification of the message to the recipient, and the message is marked in “notified” status.

When the delayed communication system is notified of the death of a member, or when a “date certain” message becomes due for delivery, an email message is sent to the designated recipient or recipients of the message. This notification email message may or may not disclose the name of the member that has died. In some embodiments, this message may be the message that the member himself created. In other embodiments, the notification message may be a mere notice message, which in turn invites the recipient to log on to the delayed communication system to retrieve the message content. In another embodiment, the notification email message may contain a URL to the delayed communication system, with an extended path name that causes the delayed communication system to construct a page specifically for this recipient, containing the message text, any attached forms, etc. In another embodiment, the delayed communication system may build up an HTML document and attach it to the notification email, for the recipient to open at whatever time the recipient finds convenient. The intended recipient will have the choice of reading, deleting or saving the attached delayed communication email message.

The possibility exists that the delayed communication system will send an email message to an email address that is no longer active, for instance if the recipient failed to notify the delayed communication system of a change of email address. In some embodiments, the delayed communication system may retain all email messages for a period of one year from the date of initial distribution of the notification email message. During this one year period, an intended recipient will be able to sign-on to the delayed communication system and receive any email messages intended for him or her.

The delayed communication system may also allow members to fill out announcement cards that will be sent to the individuals whose names appear in the member's address book. These announcements may be sent out immediately, on a date certain, or when notice of death is received either from a custodian or recognized in a public database.

The delayed communication system may provide friends and relatives of the deceased the ability to send flowers to the family of the deceased, for instance through a cooperative marketing relationship with an internet florist, or to donate money to a charity, using the facilities of an electronic payment system.

In some embodiments, the delayed communication system may provide a netcast service of a member's funeral. Survivors of the deceased may establish an internet hookup and a digital video camera at the funeral, to make the proceedings available to any interested person over the internet. The person, conversely, may have a digital video camera or microphone so that the person may communicate with those at the live funeral, or may provide a prerecorded message, or may type words that will be shared with the live participants through an instant messaging service.

The delayed communication system may include a library of resource centers. Each resource center may be a collection of information relating to a particular topic, for instance, estate planning, funeral planning, end-of-life care, grief and loss, spirituality, anatomical gifts, or genealogy. For instance the estate planning resource center may contain internet links to internet web sites for lawyers who specialize in wills and estate planning, hospices, funeral and mortuary service providers, life insurers, genealogy, religion, articles collected by and published on the delayed communication system, publishers or sellers of books on related topics, and other providers of content on related subjects.

Revenue may be derived from one or more of the following sources. Members may be charged a fee, as discussed above. The delayed communication system may be used to offer goods for sale to consumers, for instance books, videos, or downloadable content, for instance, related to the topics of the resource enters. The delayed communication system may sell advertising to advertisers for viewing by people who visit the site. The delayed communication system may earn referral commissions from referrals to third parties, either via web links, or through referrals to professional planning services.

The features of the delayed communication system may be made available through a third party, for instance as a “private label” brand. For instance, a bank trust department may create graphics, etc. for a front-end to the delayed communication system, so that the front-end follows the “look and feel” of the rest of the bank's web site, but the back end uses the delayed communication system's operating software and databases 102.

For the convenience of the reader, this description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

I claim:

1. A method, comprising the steps of:
by computer, soliciting from a person an electronic communication and designations of recipients of the electronic communication, and holding the electronic communication in a memory of a computer;
notifying at least one of the recipients prior to the death of the person that the at least one of the recipients has been designated to receive the electronic communication;
receiving a change of address from at least one of the recipients, and updating at least a portion of an address associated with the at least one of the recipients;
upon receiving a notice of the death of the person, transmitting the electronic communication to the recipients, and repeatedly sending a communication to at least one of the recipients on at least two anniversaries of a date specified by the person; and
automatically placing an order for goods and services for the benefit of at least one of the recipients in response to the notice of the death of the person.

2. A method, comprising the steps for:
by computer, soliciting from a person an electronic communication and designations of recipients of the electronic communication, and holding the electronic communication in a memory of a computer;
notifying at least one of the recipients prior to the death of the person that the at least one of the recipients has been designated to receive the electronic communication; and
upon receiving a notice of the death of the person, transmitting the electronic communication to the recipients.

3. A method, comprising the steps of:
by computer, soliciting from a person an electronic communication and designations of recipients of the electronic communication, and holding the electronic communication in a memory of a computer;
notifying at least one of the recipients prior to the death of the person that the at least one of the recipients has been designated to receive the electronic communication; and
upon receiving a notice of the death of the person, transmitting the electronic communication to the recipients.

4. The method of claim 3, further comprising the step of receiving the notification of death from a custodian appointed by the person.

5. The method of claim 4, further comprising the step of automatically generating a notice of the appointment and sending the notice via electronic mail to the custodian.

6. The method of claim 3, further comprising the step of receiving the notice of death from a public source of vital records.

7. The method of claim 3, further comprising the step of transmitting a communication to one of the recipients on a date certain designated by the person.

8. The method of claim 3, further comprising the step of:
upon receiving a notice of incapacity or imminent death of the person, transmitting a communication designated by the person to be sent on incapacity or imminent death, to a recipient designated by the person.

9. The method of claim 3, further comprising the step of:
customizing the appearance of a user interface for the soliciting to the appearance of a computer system of a third party, while performing the holding step and the transmitting step at a remote computer.

10. The method of claim 3, wherein at least one of the recipients is a group consisting of individual recipients, further comprising the steps of changing the individual recipients in the group to a new set of individual recipients, and transmitting the electronic communication to the new set of individual recipients.

11. The method of claim 3, further comprising the step of:
transmitting the electronic communication to at least one of the recipients as content of an electronic mail message.

12. The method of claim 3, further comprising the step of:
transmitting the electronic communication to at least one of the recipients as content retrieved from the memory in response to a demand by the at least one of the recipients, the demand being responsive to an electronic mail conveying of a location of the electronic communication.

13. The method of claim 3, further comprising the steps of:
receiving a change of address from at least one of the recipients; and
updating at least a portion of address information associated with the at least one of the recipients.

14. The method of claim 3, further comprising the step of:
repeatedly sending a communication to at least one of the recipients on at least two anniversaries of a date specified by the person.

15. The method of claim 3, further comprising the step of:
automatically placing an order for at least one of goods and services for the benefit of at least one of the recipients in response to the notice of the death of the person.

16. A computer system, comprising:
a member interface designed to initiate a person as a member in a computer-implemented content-delivery service, to receive computer-storable content from the member and designations of recipients of the computer-storable content, and to store the computer-storable content for confidential access only by the member;
a notification interface designed to notify at least one of the recipients prior to the death of the member that the at least one of the recipients has been designated to receive the computer-storable content; and
a death notice interface designed to receive a notice of the death of the member, and, on receipt of the notice of the death of the member, to send the computer-storable content received from the member to the recipients designated by the member.

17. The computer system of claim 16, wherein the death notice interface is designed to receive the notice from a custodian appointed by the member.

18. The computer system of claim 17, wherein the member interface is designed to automatically generate a notice to the custodian of the appointment of the custodian.

19. The computer system of claim 16, wherein the death notice interface is designed to receive the notice from a public source of vital records.

20. The computer system of claim 16, further comprising:
software designed to transmit the computer-storable content to at least one of the recipients on a date certain designated by the member.

21. The computer system of claim 16, further comprising:
an interface designed to receive a notice of incapacity or imminent death of the member, and, on receipt of the notice of incapacity or imminent death, to send the computer-storable content designated by the member to be sent on incapacity or imminent death, to a recipient designated by the member.

22. The computer system of claim 16, further comprising:
software designed to solicit the computer-storable content through one or more structured forms.

23. The computer system of claim 16, further comprising:
a private-label interface customized to the appearance of a computer system of a third party, emulating the functions of the member interface.

24. The computer system of claim 16, wherein at least one of the recipients is a group consisting of individual recipients, wherein the member interface is designed to enable the member to change the individual recipients in the group to a new set of individual recipients, and wherein the death notice interface transmits the electronic communication to the new set of individual recipients.

25. The computer system of claim 16, wherein the notification notice interface is designed to receive a change of address from at least one of the recipients and to update at least a portion of address information associated with the at least one of the recipients.

26. The computer system of claim 16, wherein the death notice interface is designed to repeatedly send computer-storable content to at least one of the recipients on at least two anniversaries of a date specified by the person.

27. The computer system of claim 16, wherein the death notice interface is designed to automatically place an order for at least one of goods and services for the benefit of at least one of the recipients in response to the notice of the death of the person.

28. A method, comprising the steps for:
by computer, soliciting from a person an electronic communication and designations of recipients of the electronic communication, and holding the electronic communication in a memory of a computer;
receiving a change of address from at least one of the recipients;
updating at least a portion of address information associated with the at least one of the recipients; and
upon receiving a notice of the death of the person, transmitting the electronic communication to the recipients.

29. A method, comprising the steps of:
by computer, soliciting from a person an electronic communication and designations of recipients of the electronic communication, and holding the electronic communication in a memory of a computer;
receiving a change of address from at least one of the recipients;
updating at least a portion of address information associated with the at least one of the recipients; and
upon receiving a notice of the death of the person, transmitting the electronic communication to the recipients.

30. The method of claim 29, further comprising the step of receiving the notice of death from a custodian appointed by the person.

31. The method of claim 30, further comprising the step of automatically generating a notice of the appointment and sending the notice via electronic mail to the custodian.

32. The method of claim 29, further comprising the step of receiving the notice of death from a public source of vital records.

33. The method of claim 29, further comprising the step of transmitting a communication to one of the recipients on a date certain designated by the person.

34. The method of claim 29, further comprising the step of:
upon receiving a notice of incapacity or imminent death of the person, transmitting a communication designated by the person to be sent on incapacity or imminent death, to a recipient designated by the person.

35. The method of claim 29, further comprising the step of:
customizing the appearance of a user interface for the soliciting to the appearance of a computer system of a third party, while performing the holding step and the transmitting step at a remote computer.

36. The method of claim 29, wherein at least one of the recipients is a group consisting of individual recipients, further comprising the steps of changing the individual recipients in the group to a new set of individual recipients, and transmitting the electronic communication to the new set of individual recipients.

37. The method of claim 29, further comprising the step of:
transmitting the electronic communication to at least one of the recipients as content of an electronic mail message.

38. The method of claim 29, further comprising the step of:
transmitting the electronic communication to at least one of the recipients as content retrieved from the memory in response to a demand by the at least one of the recipients, the demand being responsive to an electronic mail conveying a location of the electronic communication.

39. The method of claim 29, further comprising the step of:
repeatedly sending a communication to at least one of the recipients on at least two anniversaries of a date specified by the person.

40. The method of claim 29, further comprising the step of:
automatically placing an order for at least one of goods and services for the benefit of at least one of the recipients in response to the notice of the death of the person.

41. A computer system, comprising:
a member interface designed to initiate a person as a member in a computer-implemented content-delivery service, to receive computer-storable content from the member and designations of recipients of the computer-storable content, and to store the computer-storable content for confidential access only by the member;
an update interface designed to receive a change of address from at least one of the recipients and to update at least a portion of address information associated with the at least one of the recipients;
a death notice interface designed to receive a notice of the death of the member, and, on receipt of the notice of the death of the member, to send the computer-storable content received from the member to the recipients designated by the member.

42. The computer system of claim 41, wherein the death notice interface is designed to receive the notice from a custodian appointed by the member.

43. The computer system of claim 42, wherein the member interface is designed to automatically generate a notice to the custodian of the appointment of the custodian.

44. The computer system of claim 41, wherein the death notice interface is designed to receive the notice from a public source of vital records.

45. The computer system of claim 41, further comprising:
software designed to transmit the computer-storable content to at least one of the recipients on a date certain designated by the member.

46. The computer system of claim 41, further comprising:
an interface designed to receive a notice of incapacity or imminent death of the member, and, on receipt of the notice of incapacity of imminent death, to send the computer-storable content designated by the member to be sent on incapacity or imminent death, to a recipient designated by the member.

47. The computer system of claim 41, further comprising:
software designed to solicit the computer-storable content through one or more structured forms.

48. The computer system of claim 41, further comprising:
a private-label interface customized to the appearance of a computer system of a third party, emulating the functions of the member interface.

49. The computer system of claim 41, wherein at least one of the recipients is a group consisting of individual recipients, wherein the member interface is designed to enable the member to change the individual recipients in the group to a new set of individual recipients, and wherein the death notice interface transmits the electronic communication to the new set of individual recipients.

50. The computer system of claim 41, wherein the death notice interface is designed to repeatedly send computer-storable content to at least one of the recipients on at least two anniversaries of a date specified by the person.

51. The computer system of claim 41, wherein the death notice interface is designed to automatically place an order for at least one of goods and services for the benefit of at least one of the recipients in response to the notice of the death of the person.

52. A method, comprising the steps for:
by computer, soliciting from a person an electronic communication and designations of recipients of the electronic communication, and holding the electronic communication in a memory of a computer;
upon receiving a notice of the death of the person, transmitting the electronic communication to the recipients; and
repeatedly sending a communication to at least one of the recipients on at least two anniversaries of a date specified by the person.

53. A method, comprising the steps of:
by computer, soliciting from a person an electronic communication and designations of recipients of the electronic communication, and holding the electronic communication in a memory of a computer;
upon receiving a notice of the death of the person, transmitting the electronic communication to the recipients; and
repeatedly sending a communication to at least one of the recipients on at least two anniversaries of a date specified by the person.

54. The method of claim 53, further comprising the step of receiving the notice of death from a custodian appointed by the person.

55. The method of claim 54, further comprising the step of automatically generating a notice of the appointment and sending the notice via electronic mail to the custodian.

56. The method of claim 53, further comprising the step of receiving the notice of death from a public source of vital records.

57. The method of claim 53, further comprising the step of transmitting a communication to one of the recipients on a date designated by the person.

58. The method of claim 53, further comprising the step of:
upon receiving a notice of incapacity or imminent death of the person, transmitting a communication designated by the person to be sent on incapacity or imminent death, to a recipient designated by the person.

59. The method of claim 53, further comprising the step of:
customizing the appearance of a user interface for the soliciting to the appearance of a computer system of a third party, while performing the holding step and the transmitting step at a remote computer.

60. The method of claim 53, wherein at least one of the recipients is a group consisting of individual recipients, further comprising the steps of changing the individual recipients in the group to a new set of individual recipients, and transmitting the electronic communication to the new set of individual recipients.

61. The method of claim 53, further comprising the step of:
transmitting the electronic communication to at least one of the recipients as content of an electronic mail message.

62. The method of claim 53, further comprising the step of:
transmitting the electronic communication to at least one of the recipients as content retrieved from the memory in response to a demand by the at least one of the recipients, the demand being responsive to an electronic mail conveying a location of the electronic communication.

63. The method of claim 53, further comprising the step of:
automatically placing an order for at least one of goods and services for the benefit of at least one of the recipients in response to the notice of the death of the person.

64. A computer system, comprising:
a member interface designed to initiate a person as a member in a computer-implemented content-delivery service, to receive computer-storable content from the member and designations of recipients of the computer-storable content, and to store the computer-storable content for confidential access only by the member; and
a death notice interface designed to receive a notice of the death of the member, on receipt of the notice of the death of the member, to send the computer-storable content received from the member to the recipients designated by the member, and to repeatedly send computer-storable content to at least one of the recipients on at least two anniversaries of a date specified by the person.

65. The computer system of claim 64, wherein the death notice interface is designed to receive the notice from a custodian appointed by the member.

66. The computer system of claim 65, wherein the member interface is designed to automatically generate a notice to the custodian of the appointment of the custodian.

67. The computer system of claim 64, wherein the death notice interface is designed to receive the notice from a public source of vital records.

68. The computer system of claim 64, further comprising:
software designed to transmit the computer-storable content to at least one of the recipients on a date certain designated by the member.

69. The computer system of claim 64, further comprising:
an interface designed to receive a notice of incapacity or imminent death of the member, and, on receipt of the notice of incapacity of imminent death, to send the computer-storable content designated by the member to be sent on incapacity or imminent death, to a recipient designated by the member.

70. The computer system of claim 64, further comprising:
software designed to solicit the computer-storable content through one or more structured forms.

71. The computer system of claim 64, further comprising:
a private-label interface customized to the appearance of a computer system of a third party, emulating the functions of the member interface.

72. The computer system of claim 64, wherein at least one of the recipients is a group consisting of individual recipients, wherein the member interface is designed to enable the member to change the individual recipients in the group to a new set of individual recipients, and wherein the death notice interface transmits the electronic communication to the new set of individual recipients.

73. The computer system of claim 64, wherein the death notice interface is designed to automatically place an order for at least one of goods and services for the benefit of at least one of the recipients in response to the notice of the death of the person.

74. A method, comprising the steps for:
by computer, soliciting from a person an electronic communication and designations of recipients of the communication, and holding the electronic communication in a memory of a computer;
upon receiving a notice of the death of the person, transmitting the electronic communication to the recipients; and
automatically placing an order for at least one of goods and services for the benefit of at least one of the recipients in response to the notice of the death of the person.

75. A method, comprising the steps of:
by computer, soliciting from a person an electronic communication and designations of recipients of the communication, and holding the electronic communication in a memory of a computer;
upon receiving a notice of the death of the person, transmitting the electronic communication to the recipients; and
automatically placing an order for at least one of goods and services for the benefit of at least one of the recipients in response to the notice of the death of the person.

76. The method of claim 75, further comprising the step of receiving the notice of death from a custodian appointed by the person.

77. The method of claim 76, further comprising the step of automatically generating a notice of the appointment and sending the notice via electronic mail to the custodian.

78. The method of claim 75, further comprising the step of receiving the notice of death from a public source of vital records.

79. The method of claim 75, further comprising the step of transmitting a communication to one of the recipients on a date designated by the person.

80. The method of claim 75, further comprising the step of:
upon receiving a notice of incapacity or imminent death of the person, transmitting a communication designated by the person to be sent on incapacity or imminent death, to a recipient designated by the person.

81. The method of claim 75, further comprising the step of:
customizing the appearance of a user interface for the soliciting to the appearance of a computer system of a third party, while performing the holding step and the transmitting step at a remote computer.

82. The method of claim 75, wherein at least one of the recipients is a group consisting of individual recipients, further comprising the steps of changing the individual recipients in the group to a new set of individual recipients, and transmitting the electronic communication to the new set of individual recipients.

83. The method of claim 75, further comprising the step of:
transmitting the electronic communication to at least one of the recipients as content of an electronic mail message.

84. The method of claim 75, further comprising the step of:
transmitting the electronic communication to at least one of the recipients as content retrieved from the memory in response to a demand by the at least one of the recipients, the demand being responsive to an electronic mail conveying a location of the electronic communication.

85. A computer system, comprising:
a member interface designed to initiate a person as a member in a computer-implemented content-delivery service, to receive computer-storable content from the member and designations of recipients of the received content, and to store the content for confidential access only by the member;
a death notice interface designed to receive notice of the member, on receipt of notice of the death of the member, to send the content received from the member to the recipients designated by the member, and to automatically place an order for at least one of goods and services for the benefit of at least one of the recipients in response to the notice of the death of the person.

86. The computer system of claim 85, wherein the death notice interface is designed to receive the notice from a custodian appointed by the member.

87. The computer system of claim 86, wherein the member interface is designed to automatically generate a notice to the custodian of the appointment of the custodian.

88. The computer system of claim 85, wherein the death notice interface is designed to receive the notice from a public source of vital records.

89. The computer system of claim 85, further comprising:
software designed to transmit the computer-storable content to at least one of the recipients on a date certain designated by the member.

90. The computer system of claim 85, further comprising:
an interface designed to receive a notice of incapacity or imminent death of the member, and, on receipt of the notice of incapacity of imminent death, to send the computer-storable content designated by the member to be sent on incapacity or imminent death, to a recipient designated by the member.

91. The computer system of claim 85, further comprising:
software designed to solicit the computer-storable content through one or more structured forms.

92. The computer system of claim 85, further comprising:
a private-label interface customized to the appearance of a computer system of a third party, emulating the functions of the member interface.

93. The computer system of claim 85, wherein at least one of the recipients is a group consisting of individual recipients, wherein the member interface is designed to enable the member to change the individual recipients in the group to a new set of individual recipients, and wherein the death notice interface transmits the electronic communication to the new set of individual recipients.
